(19) United States
(12) Patent Application Publication
(10) Pub. No.: US 2022/0295525 A1
(43) Pub. Date: Sep. 15, 2022

(54) TERMINAL, BASE STATION, TRANSMISSION METHOD, AND RECEPTION METHOD

(71) Applicant: Panasonic Intellectual Property Corporation of America, Torrance, CA (US)

(72) Inventors: Tetsuya YAMAMOTO, Kanagawa (JP); Hidetoshi SUZUKI, Kanagawa (JP)

(21) Appl. No.: 17/633,928

(22) PCT Filed: Jun. 4, 2020
(86) PCT No.: PCT/JP2020/022199

§ 371 Date: Feb. 8, 2022

(30) Foreign Application Priority Data
Aug. 14, 2019 (JP) 2019-148879

(51) Int. Cl. H04W 72/12; H04L 5/00

(52) U.S. Cl. CPC H04W 72/1284; H04L 5/0026

(57) ABSTRACT

The present invention improves frequency utilization efficiency in wireless communication. A terminal comprises: a control circuit that applies, to first information provided to a plurality of frequency resources, coefficient patterns that have been associated with second information; and a transmission circuit that transmits the first information to which the patterns have been applied.

### TECHNICAL FIELD

The present disclosure relates to a terminal, a base station, a transmission method, and a reception method.

### BACKUROUND ART

In 3rd Generation Partnership Project (3GPP), the specification for Release 15 New Radio access technology (NR) has been completed for realization of 5th Generation mobile communication systems (5G).

For Release 16 NR, specifications for extending NR functions are being developed. For example, functional extension for utilizing NR in an unlicensed frequency band (or an unlicensed band) used in radio systems such as WiFi (registered trademark) has been studied (see, for example, Non-Patent Literature (hereinafter, referred to as “NPL”) 1).

### CITATION LIST

### Non-Patent Literature

### NPL 1

RP-191575, “Revised WID on NR-based Access to Unlicensed Spectrum,” Qualcomm, June 2019.

### NPL 2

3GPP TS38.211 V15.6.0, “3GPP TSG-RAN NR Physical channels and modulation (Release 15),” June 2019.

### NPL 3

3GPP TS38.213 V15.6.0, “3GPP TSG-RAN NR Physical layer procedures for control (Release 15),” June 2019.

### NPL 4

3GPP TSG RAN WG1 Meeting #98, “Draft Report of 3GPP TSG RAN WG1 #97 v0.3.0,” August 2019.

### NPL 5

S. Hara and R. Prasad, “Overview of multicarrier CDMA,” IEEE Communications Magazine, Vol.35, No.12, 1997.

### SUMMARY OF INVENTION

The unlicensed frequency band is a band in which a radio station license is not required when a certain condition is satisfied (which is referred to, for example, as a non-license-requiring band). The functional extension (or operation) in the unlicensed frequency band is also called “NR-U: NR Unlicensed,” for example.

In NR, for example, NR-U is useful as a complementary tool for traffic offloading to accommodate drastically increasing cellular communication

However, there is scope for further study on a method of improving the frequency utilization efficiency (e.g., spectral efficiency) in radio communication.

One non-limiting exemplary embodiment of the present disclosure facilitates providing a terminal, a base station, a transmission method, and a reception method that can improve frequency utilization efficiency in radio communication.

A terminal according to an exemplary embodiment of the present disclosure includes: control circuitry, which, in operation, applies a pattern of a coefficient to first information arranged in a plurality of frequency resources, the pattern being associated with second information; and transmission circuitry, which, in operation, transmits the first information to which the pattern is applied.

Note that these generic or specific aspects may be achieved by a system, an apparatus, a method, an integrated circuit, a computer program, or a recoding medium, and also by any combination of the system, the apparatus, the method, the integrated circuit, the computer program, and the recoding medium.

According to an exemplary embodiment of the present disclosure, it is possible to improve frequency utilization efficiency in radio communication.

Additional benefits and advantages of the disclosed exemplary embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an exemplary interlace configuration;

FIG. 2 illustrates an example of interlace allocation;

FIG. 3 is a block diagram illustrating a configuration example of a part of a base station;

FIG. 4 is a block diagram illustrating a configuration example of a part of a terminal;

FIG. S is a block diagram illustrating a configuration example of the base station;

FIG. 6 is a block diagram illustrating a configuration example of the terminal;

FIG. 7 is a flowchart illustrating an example of operation of the terminal;

FIG. 8 illustrates an example of PUCCH format 1;

FIG. 9 illustrates an application example of a pattern using a cyclic shift sequence;

FIG. 10 illustrates an application example of a pattern using a phase rotation;

FIG. 11 illustrates an application example of a pattern using a sequence number;

FIG. 12 illustrates an example of an association between an information bit and the pattern;

FIG. 13 illustrates an example of transmission-signal peak-to-average power ratio properties; and

FIG. 14 illustrates an application example of the pattern according to Variation 2

### DESCRIPTION OF EMBODIMENTS

Hereinafter, embodiments of the present disclosure will be described in detail with reference to the accompanying drawings.

### Interlace Allocation

Uplink transmission in air unlicensed frequency hand assumes, for example, that a transmission bandwidth (e.g., Occupied Channel Bandwidth (OCB)) of a terminal (e.g., also referred to as “User Equipment (UE)”) is limited to a bandwidth equal to or greater than a specified bandwidth. For NR-U, for example, application of interlace allocation (also referred to as “interlace transmission”) to a channel for uplink transmission of the terminal has been studied. Note that, the channel for uplink transmission may include, for example, an uplink data channel (e.g., Physical Uplink Shared Channel (PUSCH)) or an uplink control channel (e.g., Physical Uplink Control Channel (PUCCH)).

In interlace allocation, for example, a transmission unit (e.g., referred to as “interlace”) in uplink transmission is formed from resources in a plurality of frequency bands (e.g., referred to as “clusters”) within a system band that are arranged at equal intervals (or unequal intervals) in a frequency direction. Each of the clusters is composed of, for example, one or more consecutive frequency units. The frequency units may be, for example, Resource Blocks (RBs) (also referred to as “Physical RBs (PRBs)”) or subcarriers.

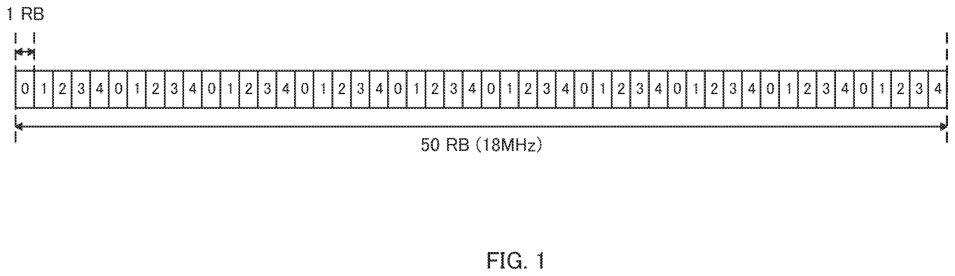

FIG. 1 illustrates an exemplary interlace configuration. In the example illustrated in FIG. 1, the system band is 20 MHz, the subcarrier spacing is 30 kHz, 1 RB is composed of 12 subcarriers, and one interlace is composed of 10 RBs (in other words, 10 clusters). As illustrated in FIG. 1, when the system band is 20 MHz (e.g., 50 RBs), five interlaces #0 to #4 can be configured. For example, in FIG. 1, each of the 10 clusters is composed of sets of five consecutive RBs. In other words, each of interlaces #0 to #4 includes RBs that are arranged at equal intervals per 5 RBs in the frequency domain. Note that, the number of RBs (in other words, the number of clusters) constituting one interlace is not limited to 10, but may be other numbers. In addition, the number of RBs (in other words, the number of interlaces) included in each cluster is not limited to 5, but may be other numbers.

### Uplink Control Information (UCI)

In NR, the terminal transmits uplink control information (UCI) to a base station (e.g., also referred to as gNB or eNB) using an uplink control channel (e.g., PUCCH). The UCI may include, for example, a response signal (also referred to, e.g., as Acknowledgement/Negative Acknowledgement (ACK/NACK), or HARQ-ACK) indicating an error detection result for a downlink data signal (e.g., Physical Downlink Shared Channel (PDSCH)), a downlink channel state information (e.g., Channel State Information (CSI)), or an uplink radio resource assignment request (e.g., Scheduling Request (SR)).

In NR, for example, PUCCH format 0 (also referred to as NR PUCCH format 0) or PUCCH format 1 (also referred to as NR PUCCH format 1) is used as a signal format when the terminal transmits 1- or 2-bit UCI (see, for example, NPL 2 or 3). PUCCH format 0 is composed of, for example, 1 or 2 symbols, and PUCCH format 1 is composed of, for example, 3 to 14 symbols.

### Transmission Method in Unlicensed Frequency Band

NR-U also assumes that PUCCH format 0 or PUCCH format 1 is used when the terminal transmits 1- or 2-bit UCI.

However, since PUCCH format 0 and PUCCH format 1 are composed of 1 RB, OCB requirements in the unlicensed frequency hand cannot be satisfied, for example.

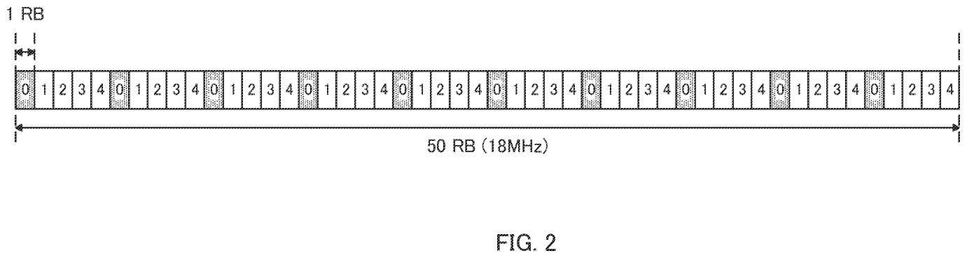

In view of the above, for example, it may be assumed that PUCCH format 0 and PUCCH format 1 are extended to interlace allocation in order to satisfy the OCB requirements. For example, as illustrated in FIG. 2, it may be assumed that the terminal repetitively arranges, in a plurality of PRBs included in an interlace (interlace #0 in the example of FIG. 2), a signal in PUCCH format 0 or PUCCH format 1 composed of 1 RB, and transmits the signal.

By extension of signals in PUCCH format 0 and PUCCH format 1 to the interlace allocation, conditions in unlicensed frequency bands (e.g., OCB requirements) may, for example, be satisfied.

However, in the interlace allocation for signals in PUCCH format 0 and PUCCH format 1 signals, one terminal occupies more radio resources than in NR (e.g., 1 PRB) to transmit 1- or 2-bit information bits. The frequency utilization efficiency can thus decrease.

As a method for suppressing a decrease in the frequency utilization efficiency, for example, a method of repetitively arranging the same signal in a plurality of RBs and further using a Multi-Carrier Code Division Multiple Access (MC-CDMA) applying a orthogonal spreading code (e.g., Orthogonal Cover Code (OCC)) is conceivable (for example, see NPL 5). In the MC-CDMA applying the OCC, it is possible to multiplex signals of a plurality of terminals onto the same time and frequency resources by the orthogonal spreading code, so as to improve the frequency utilization efficiency.

However, unlicensed frequency bands are expected to be applied, for example, in small cells. It is assumed that the nwnber of terminals in a small cell is less than the number of terminals in a macro cell. Therefore, in the unlicensed frequency bands, it is difficult to achieve improvement in the frequency utilization efficiency by multiplexing a plurality of terminals by the MC-CDMA.

Moreover, when a signal in PUCCH format 0 or PUCCH format 1 is simply repetitively arranged and transmitted in a plurality of RBs included in an interlace, the transmission-signal peak-to-average power ratio (Peak-to-Average Power Ratio (PAPR)) or Cubic Metric (CM) of the terminal may increase. In order to suppress an increase in PAPR or CM (hereinafter, also referred to as “PAPR/CM”), for example, switching (in other words, cycling) of Cyclic Shift sequences, phase rotations, or sequence numbers applied to the signal in PUCCH format 0 or PUCCH format 1 for each of a plurality of PRBs included in the interlace has been studied (see, for example, NPL 4).

However, a method of switching the Cyclic Shift sequences, phase rotations, or sequence numbers applied to the signal in PUCCH format 0 or PUCCH format 1 has not been fully discussed. Further, for example, in the MC-CDMA applying the OCC described above, it may be impossible to suppress an increase in PAPR/CM only by applying the orthogonal spreading code such as a Walsh-Hadamard code or Discrete Fourier Transform (DFT) code.

In view of the above, in one exemplary embodiment of the present disclosure, a method for suppressing an increase in PAPR/CM and improving the frequency utilization efficiency in the case of repetitively arranging and transmitting the same signal in a plurality of frequency resources as in the interlace allocation will be described.

For example, in one exemplary embodiment of the present disclosure, the terminal repetitively arranges and transmits the same signal in a plurality of frequency resources (e.g., RBs on an interlace). Here, the signal that is repetitively arranged in a plurality of frequency resources is defined as a “basic transmission unit” (e.g., basic unit). Note that the signal used as a unit (or a transmission unit) repetitively arranged in a plurality of frequency resources may be defined by a name different from the “basic transmission unit.”

The basic transmission unit may be, for example, a signal in PUCCH format 0 or PUCCH format 1 composed of 1 RB for transmitting 1 or 2 bits. Note that, the basic transmission unit is not limited to PUCCH format 0 and PUCCH format 1, and may be other signals. For example, the basic transmission unit may be a signal in another PUCCH format defined in NR or LTE, or may be other channels (e.g., PUSCH or Physical Random Access Channel (PRACH)) different from the PUCCH.

Further, in one exemplary embodiment of the present disclosure, for example, a cyclic shift amount or phase rotation amount is applied to each of the plurality of frequency resources in which the basic transmission unit is repetitively arranged. Alternatively, when the basic transmission unit is a sequence transmission, the sequence number of a transmission sequence may be configured in each of a plurality of frequency resources in which the basic transmission unit is repetitively arranged. Application of the cyclic shift amount, the phase rotation amount, or the sequence number of the transmission sequence to each of the plurality of frequency resources makes it possible to suppress an increase in PAPR/CM.

Further, in one exemplary embodiment of the present disclosure, for example, a set (or element sequence) including, as an element, a cyclic shift sequence (in other words, cyclic shift amount), the phase rotation amount, or the sequence number of the transmission sequence applied to each of a plurality of frequency resources is defined as a “pattern.” For example, the pattern is a pattern of a coefficient (e.g., cyclic shift sequence, phase rotation amount, or transmission sequence) that is applied to the basic transmission unit (in other words, the basic transmission urnit is multiplied by the coefficient).

For example, in the configuration example of the interlace illustrated in FIG. 1 or FIG. 2. one interlace is configured by 10 RBs (in other words, 10 clusters). Accordingly, the pattern includes 10 elements (e.g., cyclic shift amounts, phase rotation amounts, or sequence numbers) applied to the respective RBs.

For example, the terminal selects one pattern from a plurality of patterns, and transmits a signal based on the selected pattern. For example, an information bit is assigned to each of a plurality of patterns. By this assignment of the information bit, the terminal is capable of not only transmission of the information bit by the basic transmission unit but also transmission of the information bit by pattern selection, for example. It is thus possible to improve the frequency utilization efficiency. In addition, the plurality of patterns that can be selected by the terminal may be, for example, patterns that suppress an increase in PAPR/CM.

It is thus possible to suppress an increase in PAPR/CM and improve the frequency utilization efficiency, for example, in the case of repetitively arranging and transmitting the same signal in a plurality of frequency resources as in the interlace allocation.

### Overview of Communication System

A communication system according to each embodiment of the present disclosure includes base station 100 and terminal 200.

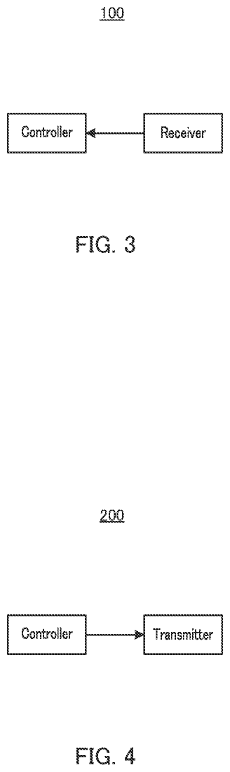

FIG. 3 is a block diagram illustrating a configuration example of a part of base station 100 according to an exemplary embodiment of the present disclosure. In base station 100 illustrated in FIG. 3, a receiver (e.g., corresponding to the reception circuitry) receives first information (e.g., the basic transmission unit) arranged in a plurality of frequency resources (e.g., RBs included in an interlace). A controller (e.g., corresponding to the control circuitry) detects second information associated with a pattern of coefficients applied to the first information.

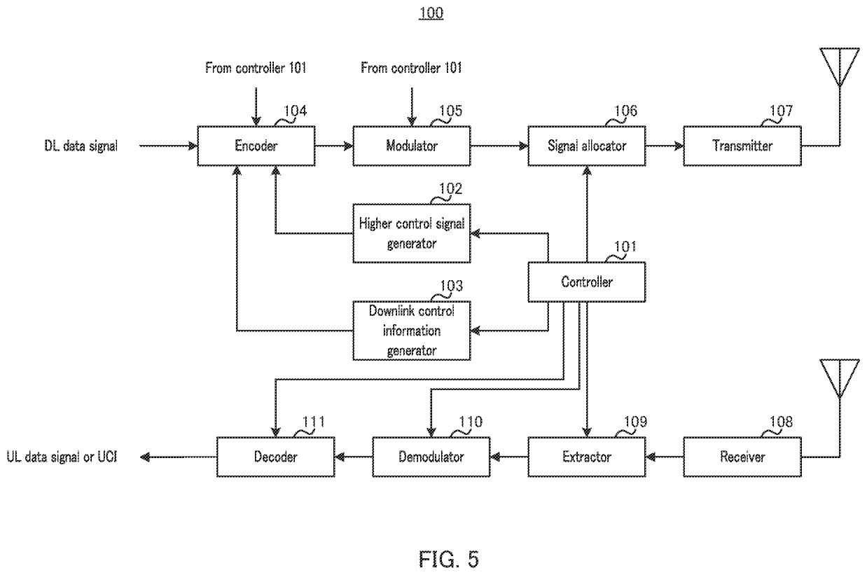

FIG. 4 is a block diagram illustrating a configuration example of a part of terminal 200 according to an exemplary embodiment of the present disclosure. In terminal 200 illustrated in FIG. 4, a controller (e.g., corresponding to the control circuitry) applies the pattern of coefficients associated with the second information to the first information arranged in a plurality of frequency resources. A transmitter (e.g., corresponding to the transmission circuitry) transmits the first information.

Note that, the “pattern of coefficients” may, for example, be a pattern including, as its elements, cyclic shift amounts, phase rotation amounts, or sequence numbers of a transmission sequence.

### Configuration of Base Station

FIG. 5 is a block diagram illustrating a configuration example of base station 100 according to Embodiment 1. In FIG. 5, base station 100 includes controller 101, higher control signal generator 102, downlink control information generator 103, encoder 104, modulator 105, signal allocator 106, transmitter 107, receiver 108, extractor 109, demodulator 110, and decoder 111. For example, controller 101, demodulator 110, and decoder 111 illustrated in FIG. 5 correspond to the controller illustrated in FIG. 3, and receiver 108 illustrated in FIG. 5 may correspond to the receiver illustrated in FIG. 3.

For example, controller 101 determines configuration information (for example, referred to as Radio Resource Control (RRC) configuration information) including higher layer parameters for terminal 200, and outputs the determined RRC configuration information to higher control signal generator 102, extractor 109, demodulator 110, and decoder 111.

The RRC configuration information may include, for example, configuration information on a transmission method for an information bit. The configuration relevant to the transmission method for the information bit may include, for example, information on transmission parameters used to generate the “basic transmission unit,” information on the information bit and the number of information bits transmitted using the “pattern,” information on the pattern configured for terminal 200, and information on the association between the information bit and the pattern.

Controller 101 also determines information on a downlink signal for transmission of a downlink data signal (e.g., PDSCH), a higher control signal, or downlink control information (e.g., DCI). The information on the downlink signal may include, for example, information such as a Modulation and Coding Scheme (MCS) and radio resource allocation. Controller 101 outputs, for example, the determined information to encoder 104, modulator 105, and signal allocator 106. Further, controller 101 outputs the information on the downlink signal to downlink control information generator 103.

In addition, controller 101 determines information for terminal 200 to transmit ACK/NACK for downlink data, and outputs the determined information to downlink control information generator 103 and extractor 109. The information for transmission of the ACK/NACK may include, for example, information on a PUCCH resource.

In addition, controller 101 determines information for terminal 200 to transmit uplink data, and outputs the determined information to downlink control information generator 103, extractor 109, demodulator 110, and decoder 111. The information for transmission of the uplink data may include, for example, a modulation and coding scheme and radio resource allocation.

Higher control signal generator 102 generates a higher layer control signal bit sequence based on the information inputted from controller 101 (e.g., based on the RRC configuration information), and outputs the higher layer control signal bit sequence to encoder 104.

Downlink control information generator 103 generates a downlink control information (e.g., DCI) bit sequence based on the information inputted from controller 101, and outputs the generated DCI bit sequence to encoder 104. Note that, the control information may be transmitted to a plurality of terminals. For this reason, downlink control information generator 103 may scramble the PDCCH transmitting the DCI by terminal-specific identification information. The terminal-specific identification information may, for example, be information such as any of a Cell Radio Network Temporary Identifier (C-RNTI) and a Modulation and Coding Scheme C-RNTI (MCS-C-RNTI), or may also be other information (e.g., another RNTI).

Based on the information inputted from controller 101 (e.g., information on a coding rate), encoder 104 encodes, for example, the downlink data (also referred to as “downlink UP data,” for example), the bit sequence inputted from higher control signal generator 102, or the DCI bit sequence inputted from downlink control information generator 103. Encoder 104 outputs the encoded bit sequence to modulator 105.

Modulator 105 modulates the encoded bit sequence inputted from encoder 104, for example, based on the information inputted from controller 101 (e.g., information on a modulation scheme), and outputs the modulated signal (e.g., symbol sequence) to signal allocator 106.

Signal allocator 106 maps the symbol sequence inputted from modulator 105 (e.g., including the downlink data or control signal) to radio resources based on the information inputted from controller 101 that indicates the radio resources. Signal allocator 106 outputs, to transmitter 107, a downlink signal in which a signal is mapped.

Transmitter 107 performs transmission waveform generation processing such as, for example, Orthogonal Frequency Division Multiplexing (OFDM) on the signal inputted from signal allocator 106. Further, transmitter 107 performs Inverse Fast Fourier Transform (IFFT) processing on the signal in the case of OFDM transmission with addition of a cyclic prefix (CP), and adds a CP to the signal subjected to IFFT. Further, transmitter 107 performs RF processing such as D/A conversion and up-conversion on the signal, and transmits a radio signal to terminal 200 via an antenna.

Receiver 108 performs RF processing such as down-conversion or A/D conversion on an uplink signal from terminal 200 received via the antenna. Further, in the case of OFDM transmission, receiver 108 performs Fast Fourier Transform (FFT) processing on the reception signal, and outputs a resulting frequency-domain signal to extractor 109.

Extractor 109 extracts, based on the information inputted from controller 101, a radio resource portion in which the uplink signal transmitted by terminal 200 is transmitted, and outputs the extracted radio resource portion to demodulator 110.

Based on the information inputted from controller 101 (for example, information on a basic transmission unit and a pattern), demodulator 110 demodulates a signal (for example, at least one of UCI and uplink data) inputted from extractor 109. Demodulator 110 detects, for example, the pattern applied to the signal inputted from extractor 109. Demodulator 110 detects (in other words, demodulates) the information bit (second information) associated with the detected pattern. Demodulator 110 demodulates, for example, the basic transmission unit included in the signal inputted from extractor 109, and obtains a demodulation result relating to the first information. Demodulator 110 outputs, for example, the demodulation result to decoder 111.

Decoder 111 performs error correction decoding on at least one of the UCI and the uplink data based on the information inputted from controller 101 and the demodulation result (the demodulation result relevant to the first information, the demodulation result relevant to the second information, or both of them) inputted from demodulator 110 to obtain a decoded received bit sequence. Note that, decoder 111 does not have to perform the error correction decoding on the UCI which is transmitted without error correction coding being performed thereon.

### Configuration of Terminal

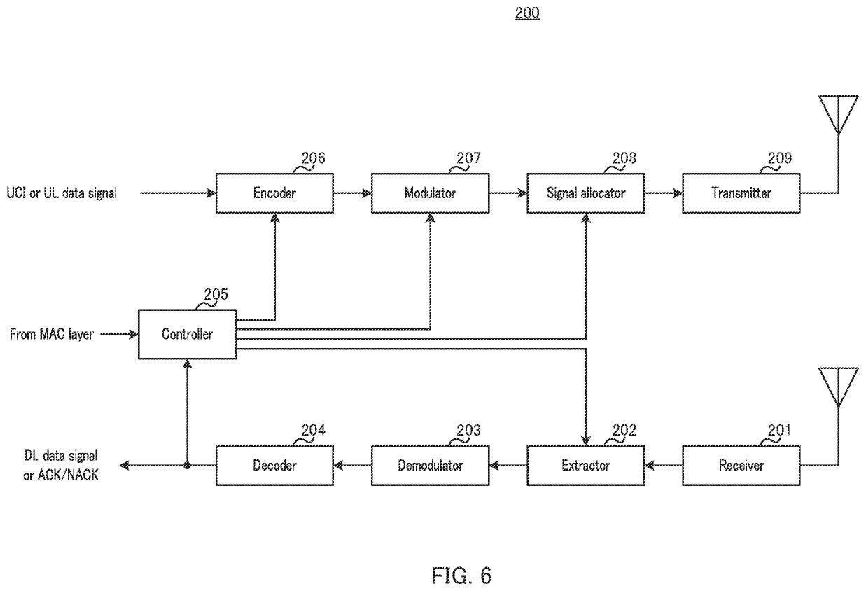

FIG. 6 is a block diagram illustrating a configuration example of terminal 200 according to an exemplary embodiment of the present disclosure. In FIG. 6, for example, terminal 200 includes receiver 201, extractor 202, demodulator 203, decoder 204, controller 205, encoder 206, modulator 207, signal allocator 208, and transmitter 209. For example, controller 205, encoder 206, modulator 207, and signal allocator 208 illustrated in FIG. 6 correspond to the controller illustrated in FIG. 4, transmitter 209 illustrated in FIG. 6 may correspond to the transmitter illustrated in FIG. 4.

Receiver 201 receives a downlink signal (e.g., downlink data or downlink control information) from base station 100 via an antenna, and performs RF processing such as down-conversion or A/D conversion on a radio reception signal to obtain a reception signal (baseband signal). Further, when receiving an OFDM signal, receiver 201 performs the FFT processing on the reception signal, and converts the reception signal into a frequency domain. Receiver 201 outputs the reception signal to extractor 202.

Extractor 202 extracts, from the reception signal inputted from receiver 201, a radio resource portion that may include the downlink control information, based on information on a radio resource in the downlink control information inputted from controller 205, and outputs the extracted radio resource portion to demodulator 203. Further, extractor 202 extracts a radio resource portion including the downlink data based on information on a radio resource for the data signal inputted from controller 205, and outputs the radio resource portion to demodulator 203.

Demodulator 203 demodulates the signal inputted from extractor 202 and outputs the demodulation result to decoder 204.

Decoder 204 performs error correction decoding on the demodulation result inputted from demodulator 203, and obtains, for example, downlink received data, a higher layer control signal, or downlink control information. Decoder 204 outputs the higher layer control signal and downlink control information to controller 205, and outputs the downlink received data. In addition, decoder 204 may generate ACK/NACK based on the decoding result for the downlink received data. The ACK/NACK may be outputted to encoder 206, for example.

For example, controller 205 determines information on the basic transmission unit and the pattern based on the configuration information on the transmission method for the information bits that is included in the higher layer control signal information inputted from decoder 204, and outputs the determined information to encoder 206, modulator 207, and signal allocator 208.

Further, controller 205 determines information on transmission of the uplink signal and outputs the determined information to encoder 206 and signal allocator 208. Further, controller 205 determines information on reception of the downlink signal and outputs the determined information to extractor 202.

Encoder 206 encodes at least one signal of the UCI or the uplink data based on the information (for example, information on the basic transmission unit) inputted from controller 205, and outputs the encoded bit sequence to modulator 207. Note that, terminal 200 may transmit an uplink signal (e.g., UCI) without error correction coding being performed in encoder 206.

Modulator 207 modulates, based on the information inputted from controller 205, the encoded bit sequence inputted from encoder 206, and outputs a modulated signal (symbol sequence) to signal allocator 208. For example, regarding the bit sequence transmitted in the basic transmission unit, modulator 207 may generate the basic transmission unit based on the bit sequence to output the basic transmission unit to signal allocator 208. Further, regarding the bit sequence transmitted by the pattern, modulator 207 selects the pattern based on the bit sequence, and outputs information on the selected pattern to signal allocator 208.

Signal allocator 208 maps, based on the information inputted from controller 205, the signal inputted from modulator 207 to the radio resources, and outputs, to transmitter 209, the uplink signal in which the signal is mapped. For example, signal allocator 208 may repetitively arrange the basic transmission unit in a plurality of frequency resources (e.g., interlace). Signal allocator 208 may apply the pattern (e.g., cyclic shift amounts, phase rotation amounts, or sequence numbers) to the basic transmission unit allocated to a plurality of frequency resources.

Transmitter 209 performs, on the signal inputted from signal allocator 208, transmission signal waveform generation such as OFDM, for example. Further, in the case of OFDM transmission using the CP, transmitter 209 performs IFFT processing on the signal and adds the CP to the signal subjected to IFFT. Alternatively, when transmitter 209 generates a single-carrier waveform, a Discrete Fourier Transform (DFT) section may be added on the downstream side of modulator 207 or on the upstream side of signal allocator 208 (not illustrated). Further, transmitter 209 performs the RF processing such as D/A conversion and up-conversion on a transmission signal, and transmits a radio signal to base station 100 via the antenna.

### Operation Example of Base Station 100 and Terminal 200

An operation example of base station 100 and terminal 200 having the above configurations will be described.

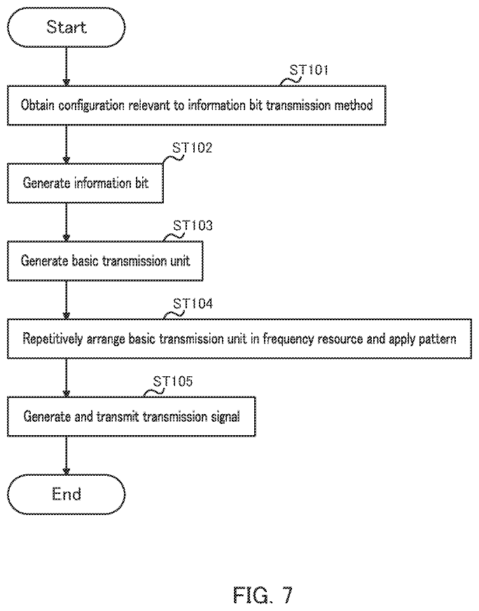

FIG. 7 is a flowchart illustrating an example of the operation of terminal 200 according to the present embodiment.

In FIG. 7, terminal 200 obtains, for example, configuration information on a transmission method for transmitting an information bit (ST101). The configuration information may be configured for terminal 200 by base station 100 by a control signal such as a higher layer parameter (e.g., RRC parameter) or DCI, or may be configured in advance for terminal 200 according to the specifications.

The configuration information on the transmission method for transmitting the information bit may include, for example, information on transmission parameters used to generate the “basic transmission unit,” information on the information bit and the number of bits to be transmitted using the “pattern,” information on the pattern configured for terminal 200, or information on the association between the information bit and the pattern.

In addition, the information bit may be UCI such as ACK/NACK, SR, or CSI described above, uplink U-plane data, or other information.

Terminal 200 generates an information bit (ST102).

For example, terminal 200 generates a basic transmission unit based on the configuration information on the transmission method for transmitting the information bit and based on the generated information bit (ST103).

Terminal 200 arranges the basic transmission unit, for example, in a plurality of frequency resources (e.g., interlace) (ST104). In addition, terminal 200 applies a pattern to the basic transmission unit arranged in the plurality of frequency resources, for example, based on the configuration information on the transmission method for transmitting the information bit (ST104).

Terminal 200 generates a transmission signal including a signal in which the basic transmission unit is arranged in the plurality of frequency resources, and transmits the transmission signal to base station 100 (ST105).

### Generation Method for Generating Basic Transmission Unit

Next, exemplary generation of the basic transmission unit will be described.

The basic transmission unit may be a signal in a signal format for transmitting one or two bits, such as PUCCH format 0 or PUCCH format 1, for example, as defined in Release 15 NR. Note that the basic transmission unit is not limited to the above, and may be, for example, a signal in another PUCCH format defined in NR or LTE, or in a signal format of another channel (e.g., PUSCH or PRACH). In addition, the number of information bits transmitted by the basic transmission unit is not limited to 1 or 2.

In the following, the application of PUCCH format 0 or PUCCH format 1 to the basic transmission unit will be described as an example.

### PUCCH Format 0

In PUCCH format 0, a transmitting side (e.g., terminal 200) transmits a signal in which a cyclic shift sequence (e.g., having a sequence length of 12) different between information bits is mapped to one OFDM symbol and one RB (e.g., 12 subcarriers).

A receiving side (e.g., base station 100) demodulates an information bit based on the cyclic shift sequence, for example, by maximum likelihood judgment using correlation processing.

For example, a constant amplitude zero auto correlation (CAZAC) sequence may be used as the cyclic shift sequence. The CAZAC sequence has low PAPR properties.

Further, for example, in the case of PUCCH format 0 using two OFDM symbols, terminal 200 may repetitively transmit the above-described configuration in two symbols. At this time, frequency hopping may be applied between two symbols.

### PUCCH Format 1

A signal in PUCCH format 1 is composed of, for example, 4 to 14 OFDM symbols and one RB (e.g., 12 subcarriers).

In addition, in the case of PUCCH format 1, multiplication by a modulation signal based on ACK/NACK is performed, for example, after cyclic shift sequences (e.g., having a sequence length of 12) different between terminals 200 are assigned. For example, multiplication by a modulation signal based on binary phase shift keying (BPSK) is performed for a 1-bit ACK/NACK, and multiplication by a modulation signal based on quadrature phase shift keying (QPSK) is performed for a 2-bit ACK/NACK.

Further, in the case of PUCCH format 1, the modulation signal (e.g., ACK/NACK) are code-spread based on an Orthogonal Cover Code (OCC) corresponding to the number of symbols. The spread signals are arranged in odd-numbered OFDM symbols, for example.

Further, a Reference Signal (RS) (e.g., Demodulation reference signal (DMRS)) used by base station 100 to decode the information bits transmitted by terminal 200 is code-spread by a cyclic shift sequence and an orthogonal cover code (e.g., OCC). The code-spread reference signal is, for example, arranged in even-numbered OFDM symbols.

Note here that, for example, the number of the front OFDM symbol in a slot is configured to “0.” In addition, for example, the CAZAC sequence may be used as the cyclic shift sequence.

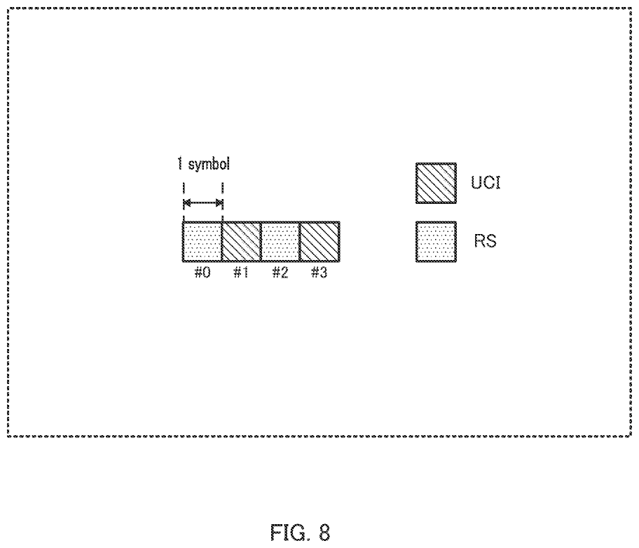

By way of example, FIG. 8 illustrates a configuration of PUCCH format 1 with four OFDM symbols.

As illustrated in FIG. 8, UCI (e.g., ACK/NACK information) is arranged in the first and third odd-numbered OFDM symbols. In addition, as illustrated in FIG. 8, the reference signal is arranged in the 0th and second even-numbered OFDM symbols.

Further, frequency hopping may also be applied in PUCCH format 1. The application of frequency hopping can increase the reception characteristics by frequency diversity.

The generation method of generating the basic transmission unit when PUCCH format 0 or PUCCH format 1 is applied has been described above.

Note that the basic transmission unit is not limited to PUCCH format 0 or a PUCCH format 1 composed of one RB, and may have another configuration. For example, the sequence length of PUCCH format 0 or PUCCH format 1 may be greater than 12 (e.g., may be 24), and the basic transmission unit may be composed of a plurality of RBs.

In addition, the basic transmission unit may also be generated based on a format (e.g., PUCCH format 2 or PUCCH format 3) in which a plurality of RBs are used (see, e.g., NPL 2 or 3).

Further, the basic transmission unit is not limited to the PUCCH formats, and may be generated based on transmission formats of other channels. For example, the basic transmission unit may be generated based on a PUSCH or PRACH.

### Repetitive Arrangement of Basic Transmission Unit and Application of Pattern

For example, terminal 200 repetitively arranges the generated basic transmission unit in a plurality of frequency resources (e.g., each RB included in an interlace).

In addition, for example, terminal 200 applies a pattern (e.g., an element such as a cyclic shift amount, phase rotation amount, or sequence number) to the basic transmission unit arranged in each of the plurality of frequency resources.

Terminal 200 may generate a time-domain transmission signal by applying, for example, Inverse Discrete Fourier Transform (IDFT) or Inverse Fast Fourier Transform (IFFT) to a frequency domain signal resulting from repetitive arrangement of the basic transmission unit in the plurality of frequency resources and application of the pattern.

For example, the pattern is a set including elements (e.g., cyclic shift amounts, phase rotation amounts, or sequence numbers) corresponding respectively to the plurality of frequency resources. In other words, the pattern includes the same number of elements as the number of frequency resources (e.g., RBs included in the interlace) in which the basic transmission unit is repetitively arranged.

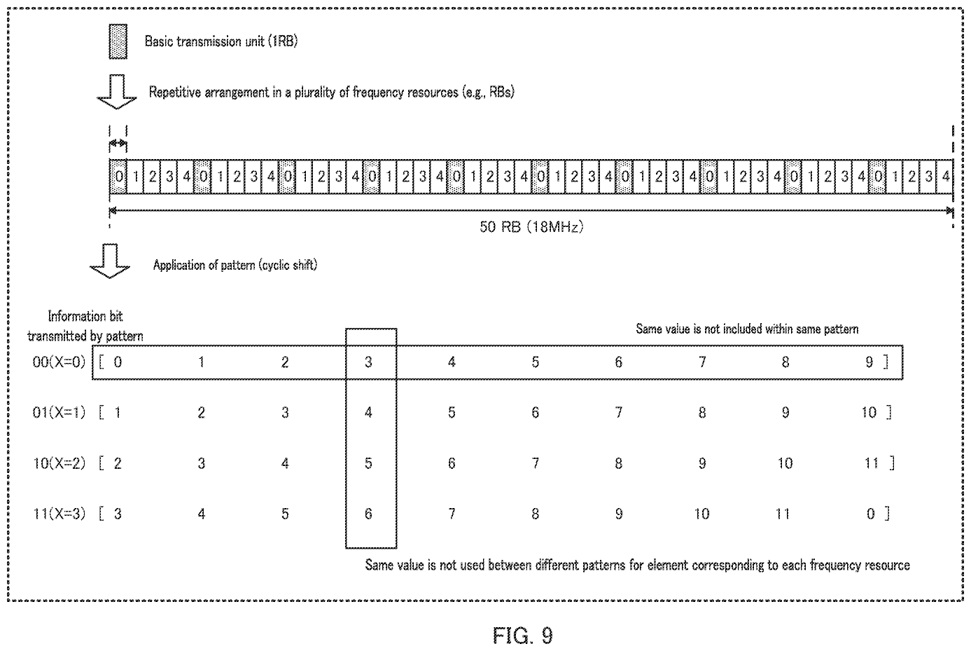

FIGS. 9, 10, and 11 respectively illustrate examples where the pattern includes as its elements the cyclic shift amounts, the phase rotation amounts, and the sequence numbers when PUCCH format 0 or PUCCH format 1 is used as the basic transmission unit.

FIG. 9 illustrates an example of the case where the pattern including cyclic shift amounts as elements is applied.

For example, when a cyclic shift amount for the basic transmission unit (in other words, PUCCH format 0 or PUCCH format 1) is “m,” the cyclic shift amount “m′(n)” for the n-th frequency resource is expressed by following Equation 1 by giving the cyclic shift amount Δₙ corresponding to the n-th element of the pattern:

m′(n)=m+Δₙ mod M_{RB} (Equation 1).

Here, “n” denotes any of 0 to N−1, and N is the number of frequency resources in which the basic transmission unit is repetitively arranged. For example, one interlace is composed of 10 RBs in the interlace configuration example illustrated in FIG. 1 or 2. Thus, N=10.

Further. “M_{RB}” denotes an applicable cyclic shift amount (e.g., upper limit value). For example, when PUCCH format 0 or PUCCH format 1 is used as the basic transmission unit, the sequence length of the cyclic shift sequence is 12. Thus, M_{RB}=12.

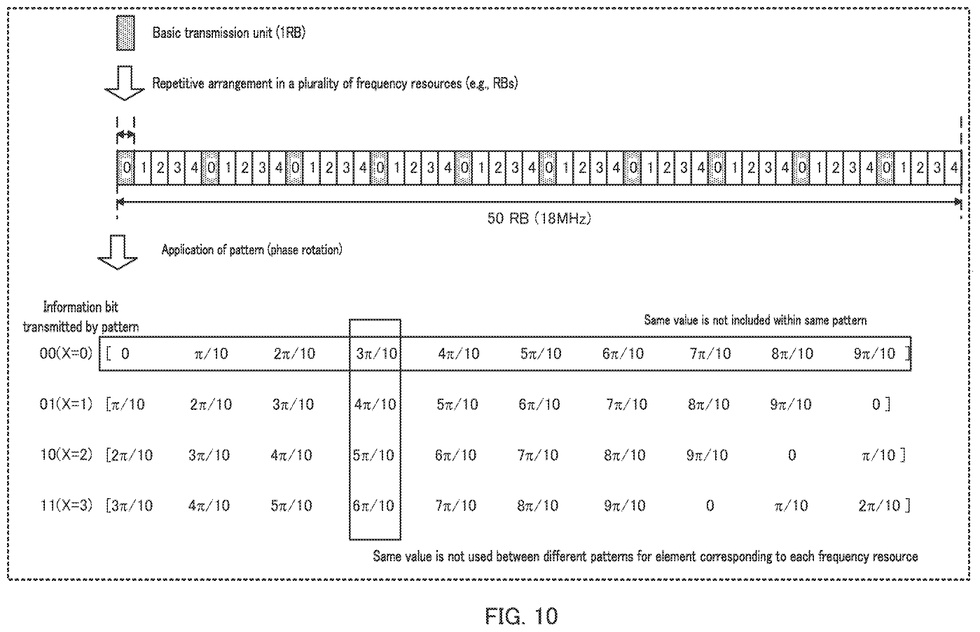

FIG. 10 illustrates an example of the case where the pattern including phase rotation amounts as elements is applied.

For example, terminal 200 multiplies the basic transmission unit arranged in the n-th frequency resource by phase rotation amount φₙ corresponding to the nth element of the pattern.

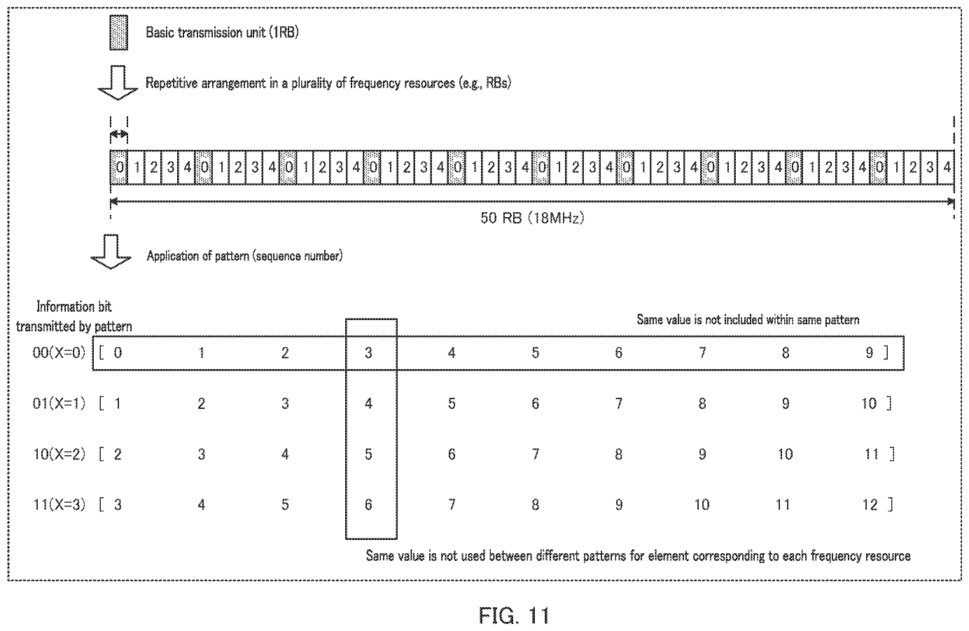

FIG. 11 illustrates an example of the case where the pattern including sequence numbers as elements is applied.

For example, when the sequence number of a CAZAC sequence used for the basic transmission unit (in other words, PUCCH format 0 or PUCCH format 1) is “u,” the sequence number “u′(n)” for the n-th frequency resource is expressed by following Equation 2 by giving sequence number δₙ corresponding to the n-th element of the pattern:

u′(n)=u+δₙ mod U (Equation 2).

Here, “n” denotes any of 0 to N−1, and N is the number of frequency resources in which the basic transmission unit is repetitively arranged. For example, one interlace is composed of 10 RBs in the interlace configuration example illustrated in FIG. 1 or 2. Thus, N=10.

Further, “U” denotes an applicable sequence number (e.g., upper limit value). For example, U=30 CAZAC sequences are configured in NR.

In addition, the sequence number “Zₙ” corresponding to the n-th element of the pattern may be configured to the sequence number u′(n) for the n-th frequency resource. For example, sequence number u′(n) for the n-th frequency resource may be represented by following Equation 3 instead of Equation 2:

u′(n)=Zₙ (Equation 3).

### Pattern Determination Method and Pattern Designing Method

Terminal 200 transmits an information bit included in a basic transmission unit and an information bit associated with a pattern to base station 100. In other words, terminal 200 explicitly transmits the information bit (e.g., first information) to base station 100 by the basic transmission unit and implicitly transmits the information bit (e.g., second information) to base station 100 by selecting the pattern.

The set of patterns (in other words, a group of candidates for the patterns) that terminal 200 can apply and the association between the patterns and information bits (a column) may be predefined, for example, according to the specifications, or may be configured (in other words, indicated) by base station 100 for terminal 200 by a control signal such as an RRC parameter or DCI.

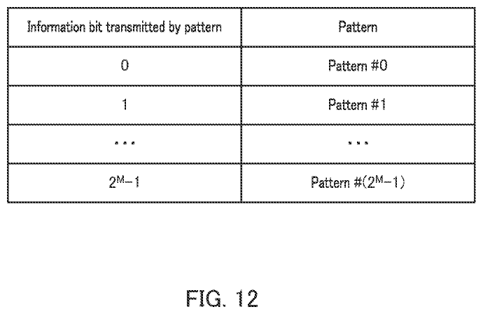

FIG. 12 illustrates an example of the association between the patterns and the information bits transmitted by terminal 200 to base station 100 according to the patterns.

As illustrated in FIG. 12, for example, when the number of information bits indicated to base station 100 by selecting the pattern is M bits, a set including 2^{M} patterns may be configured for terminal 200. Each of 2^{M} patterns is associated with information bits (a column).

As described above, the pattern is, for example, a set including as elements the cyclic shift amounts, phase rotation amounts, or sequence numbers applied to frequency resources.

By way of example, when the basic transmission unit is generated based on PUCCH format 0 or PUCCH format 1, the CAZAC sequence having a sequence length of 12 may be applied to the basic transmission unit. Further, for example, in the interlace configuration example illustrated in FIG. 1 or FIG. 2, one interlace is composed of 10 RBs, and therefore, N=10. Further, in NR, U=30 CAZAC sequences are prepared.

In this case, the number of patterns that can be generated in terminal 200 is 12^{N} patterns in the case of the patterns using the cyclic shift sequences, X^{N} patterns in the case of the patterns using the phase rotations, where X denotes the number of candidates for the phase rotation amounts, or 30^{N} patterns in the case of the patterns using the sequence numbers.

Here, not all the patterns are suitable for repetitive transmission of the basic transmission unit and transmission of the information bits associated with the patterns. Regarding a pattern usable by terminal 200 or a pattern assigned to terminal 200, for example, there is scope for further study on suppressing an increase in PAPR/CM of a transmission signal. Further, when the information bits are transmitted in association with the pattern, base station 100 judges the pattern corresponding to the information bits transmitted by terminal 200. Therefore, there is scope for further study on reception performance of base station 100, for example, with respect to the pattern usable by terminal 200 or the pattern assigned to terminal 200.

To begin with, a description will be given of patterns for suppressing an increase in PAPR/CM of transmission signals (in other words, for achieving a low PAPR/CM).

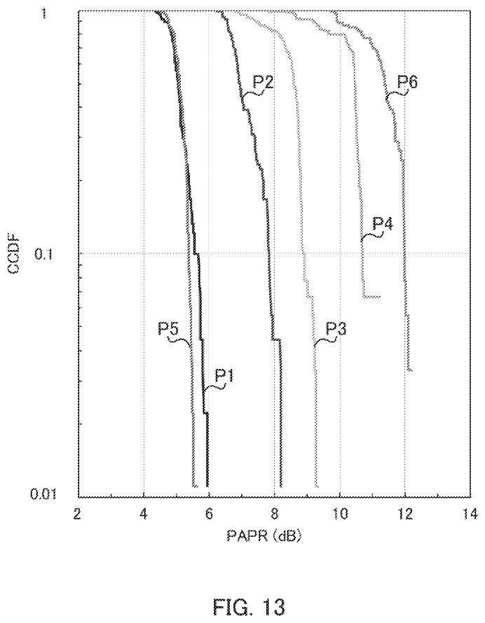

FIG. 13 illustrates exemplary PAPR properties in a case where the pattern using the cyclic shift sequences is applied to repetitive transmission of the basic transmission unit. In FIG. 13, the horizontal axis represents the value of PAPR (dB), and the vertical axis represents the Complementary Cumulative Distribution Function (CCDF). Further, like FIG. 1, FIG. 13 illustrates an example where the system band is 20 MHz, the subcarrier spacing is 30 kHz, 1 RB is composed of 12 subcarriers, one interlace is composed of 10 RBs (in other words, 10 clusters).

In addition, FIG. 13 illustrates an example of the PAPR properties in a case where the following six patterns are applied to interlace #0 among five interlaces #0 to #4 illustrated in FIG. 1, for example:
Pattern #1 (denoted by P1): [0 1 2 3 4 5 6 7 8 9]
Pattern #2 (denoted by P2): [0 2 4 6 8 10 0 2 4 6]
Pattern #3 (denoted by P3): [0 3 6 9 0 3 6 9 0 3]
Pattern #4 (denoted by P4): [0 4 8 0 4 8 0 4 8 0]
Pattern #5 (denoted by P5): [0 5 10 3 8 1 6 11 4 9]
Pattern #6 (denoted by P6): [0 6 0 6 0 6 0 6 0 6].

As illustrated in FIG. 13, patterns #1 and #5 have the PAPR properties lower than those of the other patterns #2, #3, #4, and #6.

Further, as illustrated in FIG. 13, the PAPR is greater in the order of pattern #6, pattern #4, pattern #3, and pattern #2.

According to the PAPR properties of FIG. 13, for example, the more the pattern includes the same cyclic shift amounts as the elements, the greater the PAPR becomes. In other words, patterns including fewer kinds of cyclic shift amounts as the elements may have an increased PAPR. For example, in FIG. 13, pattern #6 includes five each of two kinds of cyclic shift amounts 0 and 6, while patterns #1 and #5 include one each of ten kinds of cyclic shift amounts.

Thus, from the viewpoint of suppressing an increase in PAPR/CM of transmission signals, the patterns not including elements having the same value in one pattern may be configured for terminal 200. In other words, the more the elements having different values are included in one pattern, the higher the suppressing effect of suppressing an increase in PAPR/CM by the pattern. A plurality of elements included in one pattern may have values different from one another, for example, as in pattern #1 or pattern #5 described above.

Next, a pattern for improving the reception performance in base station 100 will be described.

For example, for each frequency resource in which the basic transmission unit is repetitively arranged, elements of different patterns (e.g., a plurality of candidates of patterns) do not have to be configured to the same value. In other words, for each of a plurality of frequency resources, the elements of the plurality of patterns may have values different from one another.

For example, the receiving side (e.g., base station 100) detects the pattern applied to a reception signal to judge an information bit transmitted by the pattern. In detection of the pattern, when the same value is configured to the elements of different patterns for a certain frequency resource, base station 100 cannot distinguish which pattern the detected pattern is for the frequency resource. Thus, the pattern detection accuracy may be lowered. Accordingly, the reception performance of base station 100 in reception of information bits associated with the pattern may be deteriorated.

On the other hand, in the case where values different between the different patterns are configured as elements for each frequency resource, base station 100 can distinguish which pattern the detected pattern is for the frequency resource. Thus, the pattern detection accuracy can be improved. It is thus possible to improve the reception performance of base station 100 in reception of the information bit associated with the pattern.

In addition, when the basic transmission unit is generated based on PUCCH format 0 or PUCCH format 1, the smaller the sum of cross-correlations between patterns in transmission sequences to which the patterns are applied, the better the reception performance of base station 100 may be.

For example, when the pattern using the cyclic shift sequences is applied and cyclic shift amounts different between different patterns are configured for each frequency resource, the sum of the cross-correlations is zero. Further, when the pattern using the sequence numbers is applied, the sum of the cross-correlations becomes smaller as sequence numbers different between different patterns are configured for each frequency resource.

The pattern for improving the reception performance of base station 100 has been described above.

For example, in FIGS. 9, 10, and 11, four types of patterns and four types of information (in other words, 2-bit information bits: 00, 01, 10, and 11) are associated with each other by way of example.

For example, in the example illustrated in FIG. 9, ten cyclic shift amounts that are elements included in each of the four types of patterns are values different from one another. Similarly, for example, in the example illustrated in FIG. 10, ten phase rotation amounts that are elements included in each of the four types of patterns are values different from each other. Similarly, in the example illustrated in FIG. 11, ten sequence numbers that are elements included in each of the four types of patterns are values different from each other.

Further, for each of the frequency resources illustrated in FIGS. 9, 10, and 11, the elements (e.g., cyclic shift amounts, phase rotation amounts, or sequence numbers) are values different from one another between the four patterns.

Therefore, terminal 200 can suppress an increase in PAPR/CM of transmission signals by applying the patterns illustrated in FIG. 9, 10, or 11 to the basic transmission unit. Further, terminal 200 can mprove the reception performance of base station 100 by applying the patterns illustrated in FIG. 9, 10, or 11 to the basic transmission unit.

Note that the present disclosure is not limited to the case where a plurality of elements included in each pattern have values different from one another, and some of the elements may, for example, have the same value. Further, the present disclosure is not limited to the case where, for each frequency resource, the elements of a plurality of patterns have values different from one another, but the elements of some of the patterns may, for example, have the same value.

In addition, the values configured to the elements included in the patterns (for example, elements corresponding to the n-th frequency resource) may be determined based on a law (for example, may be referred to as a rule, a regulation, a provision, or a configuration) the same between the patterns (in other words, information bits), as illustrated in the examples of FIGS. 9, 10, and 11, for example. In other words, a plurality of patterns (e.g., a plurality of candidates) are generated based on a law common to the values of the information bits associated respectively with the plurality of patterns.

For example, in the example of the pattern using the cyclic shift sequences illustrated in FIG. 9, when a cyclic shift amount for the basic transmission unit is “m,” cyclic shift amount m′(n) for the n-th frequency resource may be expressed as following Equation 4:

m′(n)=m+(n+b) mod M_{RB} (Equation 4).

Here, “b” denotes a value corresponding to an information bit sequence. For example, the value of b may be value X of each of the information bits illustrated in FIG. 9. Further, “M_{RB}” denotes an applicable cyclic shift amount (in other words, an upper limit value). For example, when the basic transmission unit is generated based on PUCCH format 0 or PUCCH format 1, M_{RB}=12.

According to Equation 4, for example, as illustrated in FIG. 9, the values of the elements in the four patterns that correspond to each frequency resource are configured to values shifted according to values X of the information bits. For example, when values X of the information bits corresponding to a plurality of patterns are different from one another, the values of the elements of the plurality of patterns that correspond to each of the frequency resources are different from one another. Therefore, by generating the patterns based on a law the same between different information bits, it is possible to prevent a value the same between the patterns from being configured to the elements.

Note that, while the example of the cyclic shift sequences (e.g., FIG. 9) has been described, the patterns including as elements the phase rotation amounts (e.g., FIG. 10) and the sequence numbers (e.g., FIG. 11) may also be generated in the same manner based on the same law between different information bits.

Further, a method fir generating the patterns configured for terminal 200 is not limited to the method for generating the patterns based on the same law between different information bits, and may be generated based on other methods.

### OPERATION EXAMPLE

Next, a description will be given of an exemplary use case in which terminal 200 transmits an information bit included in a basic transmission unit and an information bit associated with a pattern.

For example, a case is conceivable where terminal 200 transmits ACK/NACK in the basic transmission unit based on PUCCH format 0 or PUCCH format 1 and transmits an SR by selecting a pattern.

By way of example, a description will be given below of the operation defined in Release 15 NR and an operation example according to an exemplary embodiment of the present disclosure performed when a PUCCH resource in which the terminal transmits the SR and a PUCCH resource in which the terminal transmits the ACK/NACK are temporally overlapped with each other.

### Operation Example 1

Operation example 1 will be described in relation to an operation performed when the ACK/NACK is transmitted using PUCCH format 0 and the PUCCH resource assigned for the ACK/NACK and the PUCCH resource configured for the SR temporally overlap each other.

In Release 15 NR, a terminal multiplexes and transmits the ACK/NACK and SR in the PUCCH. At this time, the PUCCH resource is determined based on the PUCCH resource assigned for the ACK/NACK (for example, see NPL 3). Further, in addition to the PUCCH resource (e.g., cyclic shift amount) assigned for the ACK/NACK, the PUCCH resource (e.g., cyclic shift amount) for indicating the presence or absence of the SR is used. Accordingly, in Release 15 NR, the number of terminals multiplexed on the same time-frequency resources is reduced, and the frequency utilization efficiency may be lowered.

Unlike this, in the present embodiment, for example, terminal 200 generates, in the basic transmission unit, a signal in PUCCH format 0 for transmitting the ACK/NACK, applies a pattern corresponding to the presence or absence of the SR to the generated basic transmission unit, and transmits a transmission signal to base station 100.

At this time, the number of information bits indicated by the pattern is one bit (e.g., the presence of SR or the absence of SR), and the number of patterns configured for terminal 200 is two.

In the present embodiment, terminal 200 transmits the SR by the pattern. Thus, an additional PUCCH resource (e.g, cyclic shift amount) for indicating the presence or absence of the SR, for example, as required in Release 15 NR is unnecessary. Therefore, in the present embodiment, it is possible to suppress a decrease in the number of terminals multiplexed on the same time frequency resources, to suppress a decrease in the frequency utilization efficiency.

### Operation Example 2

Operation example 2 will be described in relation to an operation performed when a PUCCH resource configured for the SR is in PUCCH format 1, the ACK/NACK is transmitted using PUCCH format 1, and a PUCCH resource assigned for the ACK/NACK and the PUCCH resource configured for the SR temporally overlap each other.

In Release 15 NR, a terminal multiplexes and transmits the ACK/NACK and SR in the PUCCH. At this time, the terminal transmits the ACK/NACK using the PUCCH resource assigned for the SR in the case of positive SR (for example, in the case where the SR is present). On the other hand, the terminal transmits the ACK/NACK using the PUCCH resource assigned for the ACK/NACK in the case of negative SR (for example, in the case where the SR is absent). The base station determines the presence or absence of the SR based on, for example, the PUCCH resource in which the ACK/NACK is actually transmitted (see, for example, NPL 3). That is, in Release 15 NR, the base station performs blind detection in the PUCCH resources for the ACK/NACK and SR, for example. Thus, the reception performance may be degraded.

Unlike this, in the present embodiment, for example, terminal 200 generates, in the basic transmission unit, a signal in PUCCH format 1 for transmitting the ACK/NACK, applies a pattern corresponding to the presence or absence of the SR to the generated basic transmission unit, and transmits a transmission signal to base station 100. At this time, the number of information bits indicated by the pattern is one bit (e.g., positive SR or negative SR), and the number of patterns configured for terminal 200 is two.

In the present embodiment, for example, since base station 100 can receive the SR by detection of the pattern applied to the transmission signal from terminal 200, and thus, blind detection in a plurality of PUCCH resources such as that performed in Release 15 NR is not necessary. Therefore, in the present embodiment, it is possible to suppress the degradation of the reception performance of base station 100.

### Operation Example 3

Operation example 3 will be described in relation to an operation performed when a PUCCH resource configured for the SR is in PUCCH format 0, the ACK/NACK is transmitted using PUCCH format 1, and a PUCCH resource assigned for the ACK/NACK and the PUCCH resource configured for the SR temporally overlap each other.

In Release 15 NR, the terminal drops transmission of the SR and transmits the ACK/NACK using the PUCCH resource assigned for the ACK/NACK (see, for example, NPL 3). Therefore, in Release 15 NR, the SR is not transmitted, and the uplink frequency utilization efficiency may be degraded or a delay may be caused.

Unlike this, in the present embodiment, for example, terminal 200 generates, in the basic transmission unit, a signal in PUCCH format 1 for transmitting the ACK/NACK, applies a pattern corresponding to the presence or absence of the SR to the generated basic transmission unit, and transmits a transmission signal to base station 100. At this time, the number of information bits indicated by the pattern is one bit (e.g., positive SR or negative SR), and the number of patterns configured for terminal 200 is two.

In the present embodiment, terminal 200 can transmit the SR to base station 100 by the pattern without dropping the SR. Therefore, in the present embodiment, it is possible to suppress degradation of the uplink frequency utilization efficiency and the delay.

Operation examples 1 to 3 have been described above.

Note that the examples of transmission of the information bits based on the basic transmission unit and the pattern are not limited to above-described operation examples 1 to 3. For example, the information transmitted by the pattern is not limited to the SR, but may be ACK/NACK, CSI, or other information. Further, the information transmitted by the basic transmission unit is not limited to the ACK/NACK, but may be the SR, CSI, or other information. In addition, the information bits are not limited to the UCI such as the ACK/NACK, SR, or CSI, but may also be uplink U-plane data.

As described above, in the present embodiment, terminal 200 applies, to the basic transmission unit (e.g., the first information bit) arranged, for example, in a plurality of frequency resources as in interlace allocation, the pattern associated with the second information bit, and transmits a transmission signal. Further, base station 100 receives the basic transmission unit (e.g., the first information bit) arranged in a plurality of frequency resources as in the interlace allocation. In addition, base station 100 detects the second information hit associated with the pattern applied to the received basic transmission unit.

Through these processes, terminal 200 can transmit the information bits to base station 100 not only by the basic transmission unit but also by the pattern. Therefore, according to the present embodiment, for example, even when the basic transmission unit repetitively arranged in a plurality of frequency resources is transmitted, it is possible to improve the frequency utilization efficiency.

Therefore, according to the present embodiment, for example, even in a non-license-requiring band such as an unlicensed frequency band, the frequency utilization efficiency in radio communication can be improved.

In addition, in the present embodiment, for example, by configuring a plurality of elements included in one pattern to different values, an increase in PAPR/CM can be suppressed. Further, in the present embodiment, for example, by configuring elements for each frequency resource to values different between a plurality of patterns, it is possible to improve the reception performance of base station 100.

### Variation 1

When a basic transmission unit is generated based on PUCCH format 0, terminal 200 maps, to a basic transmission unit, a cyclic shift sequence (e.g., having a sequence length of 12; cyclic shifts #0 to #11) different, for example, depending on information bits.

When transmitting a 1-bit information bit (e.g., ACK/NACK), terminal 200 transmits, for example, bit 0 (e.g., NACK) by cyclic shift #0 and bit 1 (e.g., ACK) by cyclic shift #6.

Further, when transmitting a 2-bit information bit (e.g., ACK/NACK), terminal 200 transmits, for example, bit 00 (e.g., NACK and NACK) by cyclic shift #0, transmits bit 01 (e.g., NACK and ACK) by cyclic shift #3, transmits bit 11 (e.g., ACK and ACK) by cyclic shift #6, and transmits bit 10 (e.g., ACK and NACK) by cyclic shift #9.

In this case, regarding the pattern for improving the reception performance of base station 100, a cyclic shift set not including cyclic shifts the same between patterns may be configured for each frequency resource, for example, as described above.

For example, when a 1-bit information bit is transmitted in PUCCH format 0, the cyclic shift set corresponding to each of the frequency resources (in other words, a combination of elements of each of the plurality of patterns) may include a set such as set #0: {0, 6}, set #1: {1, 7}, set #2: {2, 8}, set #3: {3, 9}, set #4: {4, 10}, or set #5: {5, 11}.

In addition, for example, when a 2-bit information bit is transmitted in PUCCH format 0, the cyclic shill set corresponding to each of the frequency resources may include a set such as set #0: {0, 3, 6, 9}, set #1: {1, 4, 7, 10}, or set #2: {2, 5, 8, 11}.

By the above configuration of the cyclic shift set, for example, even when the cyclic shift sequence mapped in PUCCH format 0 and the cyclic shift sequence included in the pattern are applied, the cyclic shift amounts can be made different between the patterns. Therefore, according to Variation 1, the same cyclic shifts between the patterns are not configured for each frequency resource (in other words, different cyclic shifts are configured). It is thus possible to improve the reception performance of base station 100.

Note that the cyclic shift amounts configured in Variation 1 are one example, and other values may be used.

### Variation 2

The above embodiment has been described in relation to the case where terminal 200 repetitively arranges one basic transmission unit (in other words, one type of basic transmission unit) in a plurality of frequency resources such as, e.g., interlace has been described, but the present disclosure is not limited thereto.

For example, in Variation 2, terminal 200 may repetitively arrange a plurality of kinds of basic transmission units in a plurality of frequency resources. Terminal 200 may then apply patterns associated with different information bits to different basic transmission units, for example. In other words, terminal 200 applies patterns associated with the different information bits to the different basic transmission units arranged respectively in a plurality of groups into which a plurality of frequency resources are divided.

For example, in the case of N frequency resources, terminal 200 may divide the N frequency resources into frequency resources (i.e., groups) that transmit a plurality of kinds of basic transmission units. For example, when terminal 200 generates I kinds of basic transmission units, the i-th (i=0 to I−1) basic transmission unit may be repetitively arranged in Rᵢ frequency resources. At this time, the sum of Rᵢ is N, as given by following Equation 5:

Σᵢ₌₀^{I-1}Rᵢ=N (Equation 5).

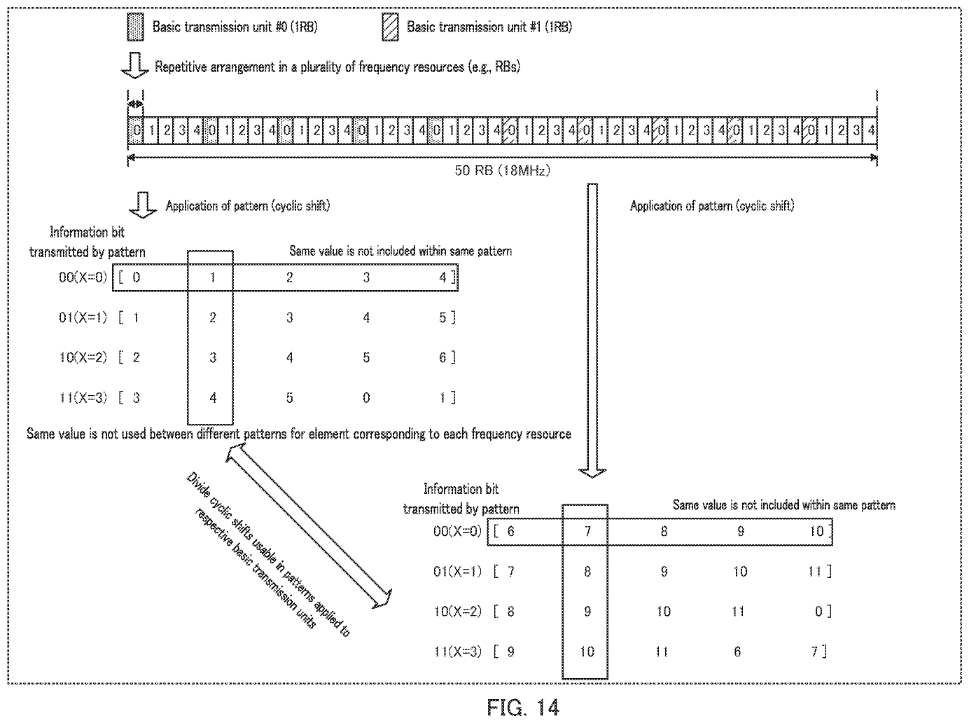

FIG. 14 illustrates an operation example according to Variation 2.

In the example illustrated in FIG. 14, N=10, I=2, and R₁=R₂=5. For example, in FIG. 14, basic transmission unit #0 is arranged in five of ten RBs included in interlace #0, and basic transmission unit #1 is arranged in the remaining five RBs.

As illustrated in FIG. 14, a different pattern is applied for each basic transmission unit. This operation allows terminal 200 to transmit a plurality of types of information bits by using different patterns respectively for a plurality of kinds of basic transmission units. It is thus possible to improve the frequency utilization efficiency. For example, in the example illustrated in FIG. 9, a 2-bit information bit is transmitted by terminal 200 to base station 100 by selecting one pattern in one interlace. Unlike this, in the example illustrated in FIG. 14, in one interlace, a 4-bit information bit is transmitted by terminal 200 to base station 100 by selecting two patterns.

Further, regarding the elements included in the pattern applied to each kind of basic transmission unit, a plurality of elements (for example, elements included in the patterns illustrated in FIG. 9) corresponding respectively to a plurality of frequency resources (10 RBs in FIG. 14) may be divided into patterns each including elements applied to corresponding one of the plurality of kinds of basic transmission units as illustrated in FIG. 14. For example, in FIG. 14, a pattern including 10 elements (cyclic shift amounts) may be divided into a pattern including the first half five elements (a pattern applied to basic transmission unit #0) and a pattern including the second half five elements (a pattern applied to basic transmission unit #1). In other words, the combination of the elements corresponding to ten RBs included in one interlace is the same between FIGS. 9 and 14.

As described above, the sets of patterns illustrated in FIG. 9 are designed in dependence on a low PAPR/CM and an improvement in reception performance of base station 100. Therefore, the design of the patterns illustrated in FIG. 14 can also achieve the properties of the low PAPR/CM and the improving effect of improving the reception performance.

Note that, by way of example, the case where the number of frequency resources (for example, the numbers of RBs) in which a. plurality of kinds of basic transmission units are arranged are the same (for example, 5 RBs) has been described with reference to FIG. 14, but the numbers of frequency resources in which the basic transmission units are arranged may be different between the basic transmission units.

In addition, by way of example, the case where the basic transmission unit of each kind is arranged in adjacent 5 RBs among a plurality of frequency resources included in the interlace has been described with reference to FIG. 14, but the present invention is not limited to this case. For example, the basic transmission unit of each kind may be arranged in discrete frequency resources among the plurality of frequency resources included in the interlace.

Further, the case where the number of kinds of basic transmission unit is two has been described with reference to FIG. 14, but the number of kinds of basic transmission unit is not limited to two, and may be any one of three to N.

Further, by way of example, the case where the patterns obtained by dividing the pattern illustrated in FIG. 9 by kind of basic transmission unit are applied has been described with reference to FIG. 14, but the patterns applied per kind of basic transmission unit are not limited to this case, and may be generated based on the size of basic transmission unit of each kind.

Further, while the patterns including the cyclic shift amounts as the elements have been described here, Variation 2 can also be applied, for example, to the patterns including the phase rotations and the sequence numbers as the elements. Further, for example, the types of elements included in the patterns applied to respective kinds of basic transmission units may be different from each other. For example, in FIG. 14, the pattern applied to basic transmission unit #0 may include the cyclic shift amounts, and the pattern applied to basic transmission unit #1 may include the sequence numbers.

The exemplary embodiment of the present disclosure has been described above.

### Other Embodiments

Note that, the above embodiment has been described in relation to the interlace arrangement as an example of resource arrangement in the frequency domain. The resource arrangement in the frequency domain is not limited to the interlace arrangement.

Further, in the above embodiment, the determination method for determining the element sequence composed of the cyclic shift amounts or the sequence numbers in the pattern is not limited to the above-described example of the element sequence (for example, FIG. 9 or 11). For example, the element sequence of cyclic shift amounts or sequence numbers included in a pattern may be generated by a pseudo-random sequence as utilized in inter-symbol hopping of cyclic shifts or inter-slot hopping of sequence numbers used in LTE or NR.

In addition, the above embodiment assumes uplink communication in which a signal is transmitted by the terminal to the base station. However, an exemplary embodiment of the present disclosure is not limited to this, and the present disclosure may be applied to downlink communication in which a signal is transmitted by the base station to the terminal, or to communication between terminals (e.g., sidelink communication).

In addition, the downlink control channel, the downlink data channel, the uplink control channel, and the uplink data channel are not limited to the PDCCH, PDSCH, PUCCH and PUSCH, respectively, but may be control channels with other names.

In addition, the unit of the time resource is not limited to the time resource (e.g., slot or sub-slot) described in each of the above embodiments, and may be another time resource unit (e.g., sub-frame, frame, or the like).

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A terminal according to an exemplary embodiment of the present disclosure includes: control circuitry, which, in operation, applies a pattern of a coefficient to first information arranged in a plurality of frequency resources, the pattern being associated with second information; and transmission circuitry, which, in operation, transmits the first information to which the pattern is applied.

In an exemplary embodiment of the present disclosure, the pattern includes an element corresponding in number to the plurality of frequency resources.

In an exemplary embodiment of the present disclosure, the element is any of a cyclic shift amount, a phase rotation amount, and a sequence number of a code sequence.

In an exemplary embodiment of the present disclosure, a plurality of the elements included in the pattern are values different from each other.

In an exemplary embodiment of the present disclosure, the element for each of the plurality of frequency resources is a value different between a plurality of the patterns.

In an exemplary embodiment of the present disclosure, a plurality of the patterns are generated based on a law common between pieces of the second information associated respectively with the plurality of patterns.

In an exemplary embodiment of the present disclosure, the control circuitry applies a plurality of the patterns respectively to different pieces of the first information arranged respectively in a plurality of groups into which the plurality of frequency resources are divided, the plurality of patterns being associated respectively with different pieces of the second information.

In an exemplary embodiment of the present disclosure, a format of the first information is PUCCH format 0 or PUCCH format 1.

In an exemplary embodiment of the present disclosure, the second information is a scheduling request.

In an exemplary embodiment of the present disclosure, the plurality of frequency resources are resources included in an interlace.

A base station according to an exemplary embodiment of the present disclosure includes: reception circuitry, which, in operation, receives first information arranged in a plurality of frequency resources; and control circuitry, which, in operation, detects second information associated with a pattern of a coefficient applied to the first information.

A transmission method according to an exemplary embodiment of the present disclosure includes steps performed by a terminal of: applying a pattern of a coefficient to first information arranged in a plurality of frequency resources, the pattern being associated with second information; and transmitting the first information to which the pattern is applied.

A reception method according to an exemplary embodiment of the present disclosure includes steps performed by a base station of receiving first information arranged in a plurality of frequency resources; and detecting second information associated with a pattern of a coefficient applied to the first information.

The disclosure of Japanese Patent Application No. 2019-148879 dated Aug. 14, 2019 including the specification, drawings and abstract is incorporated herein by reference in its entirety.

### INDUSTRIAL APPLICABILITY

An exemplary embodiment of the present disclosure is useful for mobile communication systems.

### REFERENCE SIGNS LIST

100 Base station

### 101, 205 Controller

102 Higher control signal generator
103 Downlink control information generator

### 104, 206 Encoder

### 105, 207 Modulator

106, 208 Signal allocator

### 107, 209 Transmitter

### 108, 201 Receiver

### 109, 202 Extractor

### 110, 203 Demodulator

### 111, 204 Decoder

### 200 Terminal

1. A terminal, comprising:
control circuitry, which, in operation, applies a pattern of a coefficient to first information arranged in a plurality of frequency resources, the pattern being associated with second information; and
transmission circuitry, which, in operation, transmits the first information to which the pattern is applied.

2. The terminal according to claim 1, wherein
the pattern includes an element corresponding in number to the plurality of frequency resources.

3. The terminal according to claim 2, wherein
the element is any of a cyclic shift amount, a phase rotation amount, and a sequence number of a code sequence.

4. The terminal according to claim 2, wherein
a plurality of the elements included in the pattern are values different from each other.

5. The terminal according to claim 2, wherein
the element for each of the plurality of frequency resources is a value different between a plurality of candidates for the pattern.

6. The terminal according to claim 1, wherein
a plurality of candidates for the pattern are generated based on a law common to values of the second information associated respectively with the plurality of candidates.

7. The terminal according to claim 1, wherein
the control circuitry applies a plurality of the patterns respectively to different pieces of the first information arranged respectively in a plurality of groups into which the plurality of frequency resources are divided, the plurality of patterns being associated respectively with different pieces of the second information.

8. The terminal according to claim 1, wherein
a format of the first information is PUCCH format 0 or PUCCH format 1.

9. The terminal according to claim 8, wherein
the second information is a scheduling request.

10. The terminal according to claim 1, wherein
the plurality of frequency resources are resources included in an interlace.

11. A base station, comprising:
reception circuitry, which, in operation, receives first information arranged in a plurality of frequency resources; and
control circuitry, which, in operation, detects second information associated with a pattern of a coefficient applied to the first information.

12. A transmission method, comprising steps performed by a terminal of:
applying a pattern of a coefficient to first information arranged in a plurality of frequency resources, the pattern being associated with second information; and
transmitting the first information to which the pattern is applied.

13. A reception method, comprising steps performed by a base station of:
receiving first information arranged in a plurality of frequency resources; and
detecting second information associated with a pattern of a coefficient applied to the first information.
